(19) United States
(12) Patent Application Publication
(10) Pub. No.: US 2005/0116181 A1
(43) Pub. Date: Jun. 2, 2005

(54) Non-mechanical recording and retrieval apparatus

(76) Inventor: Jerry Bohn, Barrington, IL (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/970,330

(22) Filed: Oct. 21, 2004

Related U.S. Application Data
(60) Provisional application No. 60/515,825, filed on Oct. 29, 2003.

(51) Int. Cl. G21G 5/00

(52) U.S. Cl. 250/492.1

(57) ABSTRACT

A recording and retrieval device is disclosed. The recording and retrieval device generates an electron beam which selectively exposes portions of a film to thereby record digital data on the film. An input circuit adjusts a characteristic of the electron beam selectively expose portions of the film. An anode target is exposed to the electron beam through exposed portions of the film and arranged to generate anode current indicative of digital data stored on the film. A support may secure a sheet of film such that electrons pass through exposed portions of the film. An output circuit operatively coupled to the anode couples the anode current to an external output device.

### RELATED APPLICATION

This patent claims priority from U.S. Provisional Application Ser. No. 60/515,825 which was filed on Oct. 29, 2003.

### FIELD OF THE TECHNOLOGY

The patent relates generally to a recording and retrieval device and, more particularly, to a device for both recording and retrieving data on an electron sensitive film or other suitable medium.

### BACKGROUND

The storage and retrieval of digital data plays a significant role in many areas of modern technology. For example, computers, compact disk players, digital video disk players, digitized medical x-rays, and other devices all utilize digital data. As such, each of these devices requires a medium for storing digital data and one or more mechanisms for storing and/or retrieving such data to and from the storage medium.

Due to the critical role digital data plays in the operation of many devices, it is preferable to store such data in a manner that ensures reliable retrieval. In many instances, it is also advantageous to retrieve data at a suitably high rate of speed.

Heretofore, mechanical devices have played a significant role in retrieval and recording devices. By way of example, floppy disk drives, hard disk drives, compact disk drives and digital video disk players, typically use relatively sophisticated mechanical structures which rotate the storage medium during retrieval of digital data. However, many of these mechanical devices may be susceptible to premature failure. Indeed, in the typical case, the mechanical components of conventional storage and retrieval devices fail long before the useful lives of the electronics and electrical components associated with those devices have expired. Thus, there is a continuing need for apparatus for reliably storing and retrieving digital data from a storage medium.

There are many well known storage media for storing digital data. Exemplary media include floppy disks, hard disks, compact disks, and digital video disks. Such media can be read-only, such as is typically the case with compact disks and digital video disks, or read-write, such as is typically the case with floppy disks and hard disks. Although satisfactory for storing large quantities of data, such devices are not always sufficient for storing such data when high rates of speed are desired.

Traditional storage media have suffered from certain drawbacks. For example, some traditional storage media are relatively expensive to manufacture. In addition, some traditional storage media are limited in the amount of data they can store per unit area of space they consume. For example, a traditional 3½ inch floppy disk can only store 1.44 megabytes of digital data. While some compression techniques have been used to increase the storage capabilities of the storage media, writing compressed data is slower than writing uncompressed data due to the compression process. Likewise, reading compressed data requires a decompression, which can be slower than reading uncompressed data. Thus, there is a need for an improved storage medium that is relatively inexpensive to produce and copy, and which may offer improved data storage density capabilities.

A known non-mechanical device for recording digital data and a known non-mechanical device for retrieving digital data are disclosed in U.S. Pat. No. 6,288,995. While the devices of U.S. Pat. No. 6,288,995 may overcome one or more of the drawbacks associated with the prior art by providing an apparatus for recording digital data on a film and an apparatus for retrieving the digital data from the film, the recording and retrieval devices are generally provided separately. As such, one device is used to record data on a film and another to retrieve the data from the film. Data being recorded on the non-mechanical recording device is not necessarily verified as being accurately recorded, until the recording operation is done and played back on the retrieval device.

### SUMMARY

In accordance with an aspect of the invention, the disclosed apparatus provides an apparatus for recording and retrieving digital data on a film. The apparatus includes a vacuum tube having first and second ends, and an electron gun disposed at the first end of the vacuum tube for discharging a beam of electrons into the tube. It also includes an anode target arranged to generate anode current indicative of stored digital data when exposed to electrons from the electron beam passing through exposed portions of a film.

In addition, the apparatus is provided with an input circuit operatively coupled to the vacuum tube and the electron gun, and arranged to adjust a characteristic of the electron beam to selectively expose portions of a film, and an output circuit operatively coupled to the anode target and arranged to couple the anode current generated by the anode target to an external output device.

The apparatus also includes a support arranged to secure a sheet of film between the second end of the vacuum tube and the anode target such that electrons from the electron beam pass through exposed portions of the film when the film is secured to the support.

### BRIEF DESCRIPTION OF THE DRAWINGS

FIG. 1 is a schematic illustration of a recording and retrieval device in accordance with an aspect of the invention.

FIG. 2 is a block diagram illustrating exemplary applications for the recording and retrieved device of FIG. 1.

FIG. 3 is a schematic illustration of an exemplary scanning technique.

### DESCRIPTION OF THE PREFERRED EMBODIMENTS

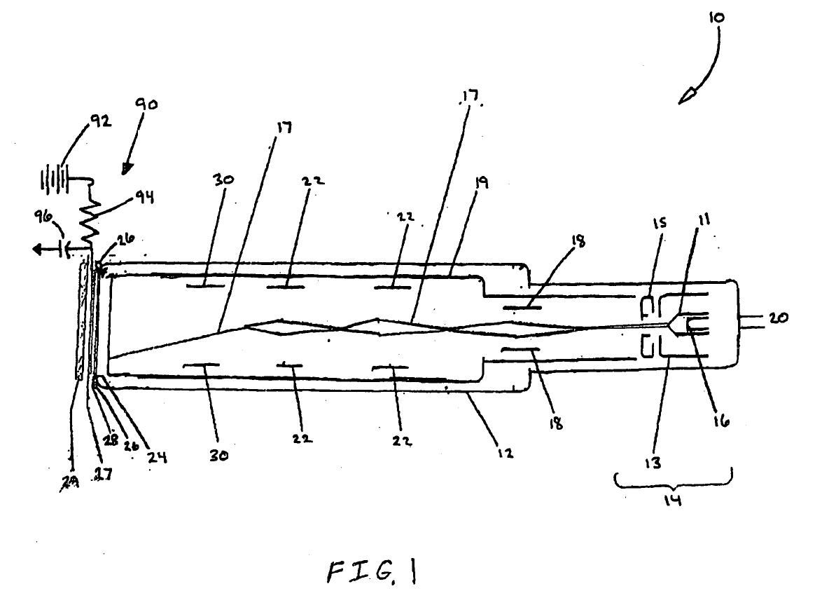

An exemplary disclosure of a recording and retrieval apparatus 10 constructed in accordance with the invention is illustrated in FIG. 1. As explained in detail below, the recording and retrieval apparatus 10 is advantageously adapted to record and retrieve data upon a suitably positioned film such as electron-sensitive film or other suitable medium without the assistance of mechanical devices. In other words, the apparatus 10 provides reliable and accurate means for recording and retrieving digital data which may not suffer from the susceptibility to mechanical failure typical of traditional recording and retrieval apparatus that rely on moving mechanical structures for operation. The combined ability to record and retrieve data may provide the recording and retrieval apparatus 10 with the capability to monitor data being recorded in real time (i.e., as the data is being recorded). The apparatus 10 may further provide a single non-mechanical device for recording data on electron-sensitive film and retrieving data previously recorded on electron-sensitive film. The disclosed recording and retrieval apparatus 10 may further provide high-density data recording capabilities by using an electron beam to encode and read data, as opposed to a combination of an electron beam and UV light because an electron beam has a much shorter wavelength than UV light. The actual density of the recording may be dependent on the resolution of the film, as recognized by those or ordinary skill in the art.

As mentioned above, the recording and retrieval apparatus 10 is preferably employed to record and retrieve data on an electron-sensitive film or other suitable medium. Although the commercially available film sold by Sterling Diagnostic Imaging Corp. under the tradename MicroVision-C is presently preferred in this role, persons of ordinary skill in the art will readily appreciate that other mediums could likewise be employed without departing from the scope of the invention. There are films that are potentially superior in terms of resolution and/or speed than the above-mentioned film. However, such potentially superior films are proprietary to the U.S. Government at the present time, and thus the above-identified MicroVision-C film remains the most preferred film presently contemplated. As film technology improves with respect to resolution and speed, the density of data stored on the film can be increased. Density may be based on the resolution of the film. High-resolution film requires a longer exposure time to the electron beam; whereas low-resolution film requires less exposure time of the electron beam. Therefore, low-resolution film can be scanned at a faster scanning rate. An inherent property of electron-sensitive film is: as the resolution (density) increases, the speed decreases. Therefore, to record very large quantities of data on the film, the recording cannot be done in real time with respect to the data source. This may not be a critical factor for most data such as videos and music. However, when it is desirable to record in real time, the quantity of data that can be recorded decreases. Some of the speed limitations can be compensated for by increasing the film processing time. There are other films that are used for laser imaging that do not use liquid processing (e.g., carbon granules) and, therefore, do not require any processing time. This type of film can also be used without departing from the scope or spirit of the invention. In any event, the film is preferably selected such that exposure to electrons (and further chemical processing) causes a darkening or lightening of the exposed sections.

For the purpose of providing a suitable environment for developing and controlling an electron beam, the recording and retrieval apparatus 10 is provided with a vacuum tube 12. The vacuum tube 12 preferably comprises a cathode-ray tube, similar to a vidicon diode gun camera tube or the low energy charged-induced voltage alterations (LEVICA) scanning electron microscope developed by Sandia National Laboratory. As shown in FIG. 1, the vacuum tube 12 includes a sealed volume which has had substantially all air removed therefrom by a pump or the like. Such vacuum tubes are commonly used in television and scanning x-ray microscopes and will not be further discussed here.

To generate an electron beam, the recording and retrieval apparatus 10 is further provided with an electron gun 14 comprising a filament 16, a cathode 11, a control grid 13 and a positive grid 15 added before the final beam-defining aperture. The electron gun 14 is arranged to provide a controllable electron beam, as discussed further herein. The filament 16 of the gun 14 is coupled to a source of highly regulated and controlled voltage supply via a lead 20. The voltage should be sufficient to generate enough heat to excite the cathode 11 to cause a high electron flow. The details of such a voltage source are known to those of ordinary skill in the art and therefore no further discussion of the voltage source is necessary. The recording and retrieval apparatus 10 is further provided with grids 18 and 19. The grids 18, 19 may be arranged to form and/or focus the electron beam, as recognized by those of ordinary skill in the art. As shown in FIG. 1, when suitably energized, the electron gun 14 will develop and discharge a beam 17 of electrons into the vacuum tube 12. Unlike a vidicon camera tube, this type of vacuum tube 12 utilizes grid control circuitry operatively coupled to the vacuum tube 12 to develop a highly defined and intense electron stream, though other forms of electron beam deflection/manipulation, as known by those of ordinary skill in the art, may likewise be utilized.

The discharged electrons are focused into a very fine beam 17 by electrostatic beam focusing and condensing lenses 22. In the preferred embodiment three such lenses 22 are provided for the tube 12 and arranged to focus the electron beam 17, but other numbers of lenses could also be employed. Regardless of the number of lenses selected, the lenses 22 (also referred to as electro-static grids) preferably generate one or more electrostatic fields which deflect and focus the electron beam 17. Preferably, the focusing electro-static lenses 22 focus the electron beam 17 to a tip of twenty-five microns or less, and, even more particularly, to a tip of one micron or less; or a dimension which is selected to match the resolution of the film. As shown in FIG. 1, the tip of the cathode 11 may be a point to help facilitate a narrow electron beam 17, as known to those of ordinary skill in the art. As will be appreciated by those of ordinary skill in the art, the lenses 22 can be implemented as either capacitive or inductive devices without departing from the scope of the invention. Electrostatic focusing is preferred because it may achieve one-or more of the following: 1) minimum geometric distortion (because of a more uniform field); 2) low shading; 3) uniform resolution over the scanned area; 4) shorter flyback (because no resonant energy is stored in the deflection coil); 5) high registration stability (because of no heating of deflection electrodes compared to the heating of deflection coils); and 6) no eddy-current losses and resultant line-start nonlinearity.

As shown in FIG. 1, the end of the vacuum tube 12 opposite the electron gun 14 is sealed by a high quality, substantially flat faceplate 24 which may be made of glass. In the embodiment shown in FIG. 1, a film support 26 is disposed adjacent the faceplate 24 and arranged such that a sheet of film 28 supported thereon can be positioned adjacent, and preferably in contact with, the faceplate 24. Preferably, the film support 26 is a frame or the like which does not interfere with electron transmission through the operative portions of the film 28. The close proximity between the film 28 and the faceplate 24 may maximize the effectiveness of the electron beam's radiation. In the recording and retrieval apparatus 10, an anode 27 is placed outside the vacuum tube 12 to increase the intensity and the quantity of the electrons.

For the purpose of directing the electron beam 17 along a predefined path, the vacuum tube 12 is further provided with an electrostatic beam deflection system comprising electrostatic electrodes (also referred to as deflection grids or scanning control grids) 30 operatively coupled to a control circuit 34. The control circuit 34 is preferably arranged to energize the electrostatic electrodes 30 to thereby direct the beam 17 along a continuous path across the surface of the faceplate 24. In the preferred embodiment, four electrostatic electrodes 30 are provided (one on each side of the vacuum tube 12; two horizontal and two vertical), and the control circuit 34 is implemented by a suitably programmed synchronization generator, as recognized by those of ordinary skill in the art. However, persons of ordinary skill in the art will readily appreciate that other numbers of electrostatic electrodes and/or other implementations of the control circuit 34 could also be employed without departing from the scope of the invention. The focusing and intensity of the electron beam must be adjusted for the distance the beam travels from side to side and top to bottom as it scans the film 28 in apparatus 10. The adjusting may be accomplished through programming of the software in the control circuit 34, as recognized by those of ordinary skill in the art and will not be further discussed herein.

In order to encode the electron beam with data to be recorded on the film 28, the recording and retrieval apparatus 10 is provided with a grid control circuit 32 operatively coupled to the electron gun 14. The control grid 13 is preferably arranged to modulate the electron beam 17 between “on” and “off” states representative of digital data to be recorded. Preferably, the electron beam 17 will not be completely turned off during recording. On the contrary, the beam is preferably generated on a continuous basis but modulated by the control grid 13 via the grid control circuit 32 to selectively and controllably switch between slightly above and slightly below the natural threshold of radiation for the film/faceplate combination (e.g., the level of voltage for which any less will not expose the film 28). In other words, the control grid 13 is arranged to modulate the beam 17 in accordance with a stream of data bits to be recorded, such that beam 17 exposes a corresponding pattern of points on the film 28 as the scanning electrostatic electrodes 30 direct the beam along its continuous path. Preferably, the film 28 is selected such that the pattern of exposed sections created by the modulated beam 17 comprises a pattern of at least semi-transparent spots. The non-exposed sections of the film will preferably prevent electrons from passing. Preferably, the electron beam 17 strikes the faceplate 24 perpendicular to the faceplate 24 to prevent changes in size and shape to the electron beam 17.

In order to generate electrical signals representative of the data being stored or previously stored on the film 28, the recording and retrieval apparatus 10 is provided with an external anode target 27. In particular, the anode target 27 is disposed behind the film 28, such that the film 28 is between the anode target and the surface of glass plate 24. The anode target 27 may be arranged to increase the intensity and the quantity of the electrons. However, as explained further, the anode target 27 negates the use of a layer of micro-fine UV photo-conductive material and a UV light source. As the electron beam 17 traces a path across the target anode 27, the target anode 27 may be arranged to output a series of electrical signals corresponding to the data stored or being stored on the film 28. The electron beam 17 is used to both record and retrieve data because of its very short wavelength and high electron stream. As a safety precaution, but not necessary for the scope of this invention, the external anode 27 may be at the same potential as the earth, and all other voltages negative according to their normal function. A lead (Pb) plate 29 may be provided behind the anode 27 to act as a safety measure due to x-rays that may be produced. Still other safety measures known to those of ordinary skill in the art or to be developed in the future may also be employed.

As shown in FIG. 1, the target anode 27 is operatively coupled to an output circuit 90. The output circuit 90 comprises a power supply 92 coupled to a biasing resistor 94, and a capacitor 96 acting as a low pass filter. As the electron beam 17 traverses the surface of the target anode 27, a series of electrical pulses corresponding to spots where light passed through the film 28 will be generated and output by the circuit 90.

In order to locate a light pattern corresponding to the pattern being recorded on the film 28, the target anode 27 is arranged to generate anode current when the electron beam is incident with the target anode 27. As the electron beam increases in power, there is more anode current, and as the electron beam decreases in power, there is less anode current thereby representing the “1”s and “0”s respectively. While a binary code has been described, the film 28 may experience various degrees or patterns of exposure by varying the exposure time, intensity or other characteristic of the electron beam 17. As such, those of ordinary skill in the art will recognize that, although binary encoding is described, various types of encoding may be performed using the recording and retrieval apparatus 10.

While recording digital data on the film 28, the varying anode current may be compared to the varying control grid voltage to verify whether or not there is a match between the data being input to the recording and retrieval device 10 and the data being recorded on the film. That is, as the electron beam 17 exposed some portions of the film 28 and not others during a writing process, the anode target 27 may generate anode current indicative of such data being stored on the film 28. Such a comparison may be accomplished by operatively coupling the output of the target anode 27 and an output from the control grid, to comparison hardware and/or software as known by those of ordinary skill in the art. For example, the outputs of the target anode 27 and the control grid may be operatively coupled to inputs of a standard logic circuit, whereby an output of the logic circuit may be indicative of whether the inputs are the same or different. This may be operatively coupled with a processor and a memory that may contain comparison software to determine when such a match or mismatch occurs, track such occurrences and provide alerts as appropriate when a mismatch occurs. In one example, the logic circuit, processor, memory and/or software may be provided with a suitably programmed computer or other processor-based computing device. Such a device may be embodied in or include the circuitry described further below. Any appropriate conversion of the signals from the target anode 27 and/or the control grid is likewise known to those of ordinary skill in the art and need not be described further herein. The recording and retrieval apparatus 10 is thereby capable of providing accurate, reliable and verifiable data recording.

In order to locate a light pattern corresponding to a pattern previously recorded on the film 28, the control grid 13 is preferably arranged to generate a continuous electron beam 17 at a constant “on” level while scanning the film 28. As the electron beam 17 scans the film, the non-exposed sections of the film 28 will preferably prevent most of the electrons from passing and the exposed sections of the film 28 will pass the electrons. As electrons pass through the film 28, the electron current will change the anode current because less electrons will pass through the film where it was previously exposed during the recording process which may be representative of a “0”. This is generally due to the negative exposure properties of negative film, though other film types, such as reversible film, may have the opposite effect. Conversely, where the electron beam 17 passes through the film 28, there are more electrons incident on the anode target 27 and thus more anode current which may be representative of a “1”.

In some embodiments, the electrostatic beam control system 22 is provided with a suitably programmed, microprocessor-based drive circuit. The drive circuit preferably drives the electrostatic grids 30 to locate and retrieve the data stored at predetermined locations identified via the reference target and stored coordinates mentioned above. Such an apparatus shortens retrieval times and renders the recording and retrieval apparatus 10 “random access” in that data at any location on the film 28 can be retrieved independently of the remainder of the data stored on the film 28.

In other embodiments, the drive circuit associated with the electrostatic grids 30 may be arranged to cause the electron beam 17 to continuously trace the path of the stored data from the starting point at the data path towards the end. Such an approach is advantageous in applications such as video or audio playback where continuous playback is the dominant mode of operation. Fast forwarding and/or skipping features may likewise be programmed into the drive circuit such that, upon request from a user, the recording and retrieval apparatus 10 skips ahead through the stored data. If such features are included, the film 28 is preferably provided with a map near the beginning of the data path which identifies the starting points (e.g., the starting coordinates) of certain groups of data. Providing such a map advantageously enables a user to skip ahead to predefined locations in the film. This approach permits a user to skip songs, for example, when the film 28 stores audio recordings.

Regardless of the drive circuit implementation selected, the drive circuit preferably includes an internal generator which controls the playback or retrieval rate to ensure appropriate playback speed. Where playback rate is significant, the appropriate rate is preferably stored on the film 28 and, after retrieval, is used by the internal generator of the drive circuit to playback data at the required rate.

The recording and retrieval device 10 is particularly well suited for recording and retrieving digital data. As those skilled in the art will readily appreciate, the recording and retrieval device 10 can be programmed to record digital “1”s as a dark spot (i.e., an unexposed section of film) and “0”s as an at least semi-transparent spot, or vice versa, without departing from the scope of the invention. As those skilled in the art will further appreciate, the number of bytes that can be recorded on a given sheet of film by the recording and retrieval apparatus is dependent upon the size of the electron beam, the size of the film, the resolution of the film, and the speed of the film. It is, therefore, preferable to match the size of the beam 17 to the resolution of the film 28 to maximize the amount of data a sheet of film of a given size can record. When the above-noted presently preferred film is employed, it is preferred that the electron beam be focused to one micron or less at its tip such that the exposed sections of the film have a radius of approximately one-half micron. When the preferred criteria are followed, it is estimated that a microfiche-sized piece of film will hold approximately fifty gigabytes or more of data.

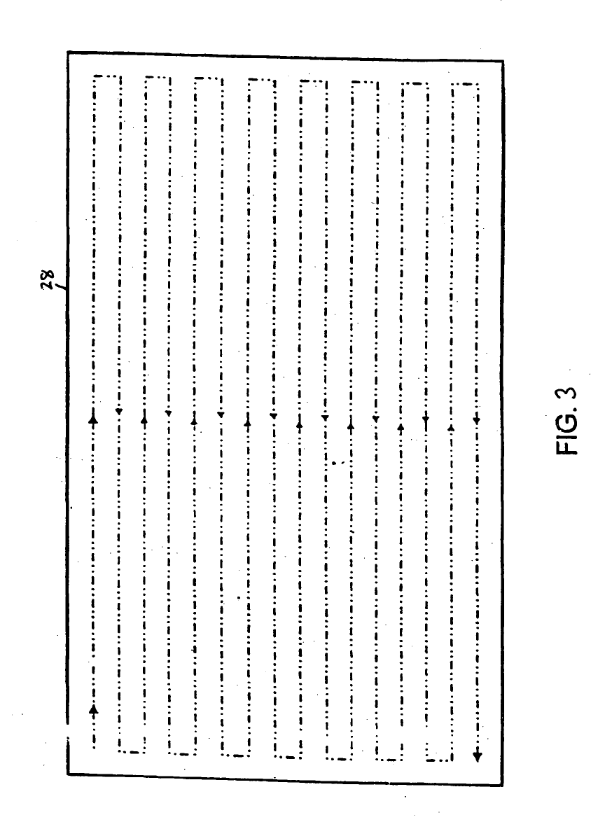

As mentioned above, the electron beam is preferably not turned off during recording thereby avoiding “splattering” of the beam and, thus, unwanted exposure of the film 28 which might otherwise be caused by turning the beam on and off. Turning the beam on and off may further cause the electron bean to lose focus and control (e.g., the tip of the electron beam returns to a default position, rather than where the writing or reading operation was stopped). Instead, varying the intensity of the electron beam is preferred. As also mentioned above, the movement of the beam 17 is preferably continuous across the film 28, thereby preventing exposure of the same spot twice. A preferred path for movement of the beam 17 across a rectangular film sheet 28 is shown in FIG. 3. Preferably, the path is completely continuous with no breaks. The dashes and dots in FIG. 3 are representative of “Ons (1's)” and “Offs (0's)”. Preferably, the physical width between horizontal paths is the same as the space between successive bits (“Ons” and “Offs”). Those skilled in the art will, however, appreciate that other paths, including, without limitation, discontinuous and/or circular paths, could also be employed without departing from the scope of the invention.

In order to facilitate subsequent playback or retrieval of the recorded data, the recording device is preferably programmed to imprint a target, symbol or pattern at a predefined location on the film. The target, symbol or pattern is then understood to represent a predefined reference location on the film (such as 0, 0 in an x, y rectangular coordinate system), which can be subsequently used to randomly locate and retrieve data stored at any desired point on the film as explained below. Preferably, the reference target is located in a corner of the film sheet at a starting point for recording data.

To further facilitate retrieval of recorded data, the control grids 13 and/or grid control circuit 32 of the recording device 10 is preferably programmed or otherwise arranged to modulate the beam 17 to record a coordinate value defined relative to the reference target for every predefined unit of data recorded on the film. For example, to record the digital byte “00000000” when the next section of film available for recording is at (1,0) in an x, y coordinate system, the apparatus 10 would record two coordinate values such as “001” and “000” followed by the byte “00000000”. While the predefined unit can comprise any convenient size or group of data bits, in the preferred embodiment the predefined unit comprises eight bits or a byte of data. Similarly, while any desired coordinate system could be employed, in the presently preferred embodiment, an x, y coordinate system keyed to the above-noted reference point is utilized. The electron beam 17 may further be modulated to carry a code that registers the location of the beam for each scan line where is should be on the film.

In order to provide a convenient means for loading film into the recording and retrieval apparatus 10, a conventional mechanical transport mechanism (not shown) can be provided for each apparatus 10. As will be appreciated by those skilled in the art, the transport mechanism can be implemented in any number of ways without departing from the scope of the invention. By way of example, not limitation, it can be implemented as a sliding drawer in a manner analogous to a conventional loading tray in a single disk compact disk player. The mechanism can be motor driven or manually powered. Optionally, film support 26 can form part of the transport mechanism. For instance, the film support 26 may comprise the sliding drawer.

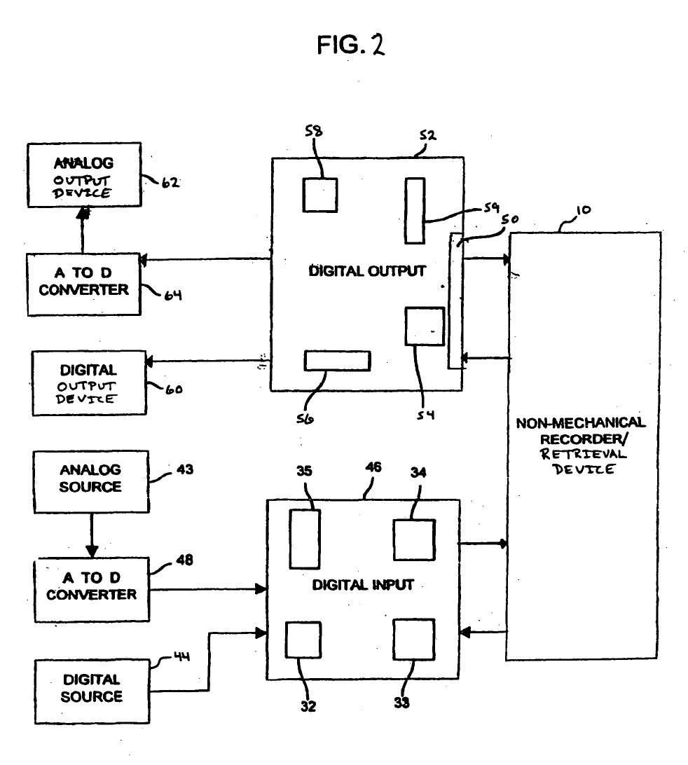

Exemplary environments of use for the recording and retrieval apparatus 10 is illustrated generally in FIG. 2. As shown in that figure, the recording and retrieval apparatus 10 can be used with both analog and digital sources 43 and 44, as well as both analog and digital output devices 62 and 60. Exemplary analog sources 43 and analog output devices 62 include, without limitation, analog televisions, video cassette recorders, audio devices and/or other devices arranged to provide and/or receive analog signals. Exemplary digital sources 44 and digital output devices 60 include, without limitation, a cd-rom, a floppy disk drive, a hard disk drive, a computer, a digital video disk player, a digital television and/or other devices arranged to provide and/or receive digital signals.

In any event, because in the preferred embodiment, the recording and retrieval apparatus 10 is arranged to record digital data, the grid control circuit 32 is preferably arranged to be provided with digital data via a digital input circuit 46 which comprises grid and beam control circuitry 32 and 34, conventional digital processing circuitry 33, and conventional encoding and error correction circuitry 35 each of which may be operatively coupled to the other and/or operatively coupled to the recording and retrieval apparatus 10. For example, the grid and beam control circuitry 32 and 34 may be coupled to the grids 13 and 30, respectively, and are arranged to cause deflection/manipulation of the electron beam 17 as described above. The digital processing circuitry 33 may be arranged to process the input signals and provide appropriate control signals to the grid and beam control circuitry 32 and 34. The error correction circuitry 35 may be arranged to provide monitoring, comparing and correcting operations during a write operation, as referred to above. As shown in FIG. 2, digital sources 44 can be directly connected or otherwise operatively coupled to the digital input circuit 46. A conventional analog to digital converter 48 is arranged to digitize the output of the analog source 43 for the digital input circuit 46. The digital input circuit 46 is preferably arranged to condition received input signals for use by the grid control circuit 32. For example, the input circuit 46 may be arranged to filter and step received signals to appropriate voltage levels for use in apparatus 10.

Also shown in FIG. 2, the recording and retrieval apparatus 10 is operatively coupled to suitable interface circuitry 50 of a digital output circuit 52. The interface circuitry 50 may be arranged to provide signal conversion or other standard interface operations between the recording and retrieval apparatus 10 and the digital output circuit 52. The digital output circuit 52 includes beam control and grid control circuitry 54, conventional error correction circuitry 56, conventional data decoding circuitry 58, and a conventional CPU and system management circuit 59, each of which may be operatively inter-coupled. Similar to the devices above, the beam control and grid control circuitry 54 may be arranged to provide signals for electron beam deflection/manipulation during a reading operation, the error correction circuitry 56 may be arranged to provide monitoring, comparing and correcting operations during a write operation, the decoding circuitry 58 may be arranged to decode anode current or other signals received from the recording and retrieval apparatus 10, and the CPU and system management circuit 59 may be arranged to process the signals from the recording and retrieval apparatus 10 and provide appropriate control signals to the various components of the digital output circuit 52. The digital output circuit 52 can be coupled directly, or otherwise operatively coupled, to a digital monitoring device 60 such as a computer, or a digital television. Alternatively, the digital output circuit 52 can be coupled through a conventional digital to analog converter 64 to an analog monitoring device 62 such as an analog television, or a stereo amplifier. The digital output circuit 52 may also be operatively coupled to the digital input circuit 46 to facilitate monitoring and verification of data being written.

As will be appreciated by those skilled in the art, the physical size of the film 28 and of the recording and retrieval apparatus 10 is determined by the intended application. For example, they can be miniaturized or constructed at a microfiche size. Similarly, the film can have a sheet format or be constructed as a coiled strip. Both the size and format are selected to accommodate the desired quantity and access rate of the data to be stored and retrieved. In one presently contemplated embodiment, a 5 inch by 5 inch square film sheet is employed.

As mentioned above, the presently preferred embodiments of the recording and retrieval apparatus 10 employ MicroVision-C film, a mammography film with excellent resolution. Since after exposure, this film cannot be erased, it is intended for write-once (i.e., single-write), read-many type applications. For example, this film could be used as an alternative to compact disks for storing audio data, or as an alternative to digital video disks, laser disks, or VHS tapes for storing video/audio data such as movies. If, however, it is desired to use the recording and retrieval apparatus 10 in write many, read many applications, an emulsion such as that used in the Magneto Optical Disk by Imation, Inc. of St. Paul, Minn., which retains its sensitivity to an electron beam after multiple exposures wherein, where applicable, successive exposures reverses the effect of predecessor exposures, could be employed. Such an emulsion would be positioned in a magnetic field during the re-write process. The noted emulsion would need to be modified to be electron-sensitive, not thermal-sensitive. Eastman Kodak and Sterling Diagnostic Imaging Corp. both sell such an electron-sensitive emulsion to the public. When such an emulsion is utilized, exemplary applications of the recording and playback apparatus include replacing a floppy disk drive and/or a hard disk drive.

In summary, persons of ordinary skill in the art will appreciate that improved data recording and retrieval apparatus have been disclosed. The recording and retrieval apparatus may include a vacuum tube, an electron gun and an anode target. The electron gun may be arranged to discharge a beam of electrons from a first end of the vacuum tube. The anode target may be arranged to generate anode current when exposed to electrons from the electron beam, such as when the electron beam passes through expose portions of a film. The anode current may be indicative of stored digital data. A sheet of film may be supported between the second end of the vacuum tube and the anode target. The sheet of film may be supported by a support such that electrons pass through exposed portions of the film. An input control circuit operatively coupled to the electron gun and the vacuum tube may be provided to adjust a characteristic of the electron beam to selectively expose portions of the film. An output circuit operatively coupled to the anode may be provided to couple the anode current to an external output device.

Among the advantages that may be enjoyed by the improved apparatus are: the ability to store more data per unit of media volume (e.g., greater data density storage) than prior art devices; recording and near instant random access retrieval of data (e.g., near-zero “seek-time”); enhanced durability as mechanical parts which can wear out, become misaligned, or require maintenance, are not used in recording or retrieving data from a suitably positioned film; universality of the data storage film (e.g., the same piece of film can be employed to store and retrieve data by disparate devices such as a computer, an audio system and a video system, and data stored by one such device can be retrieved and used by another); economic manufacturability using existing facilities and existing methods of mass distribution; ease of mass-duplication (e.g., as with conventional photographic film, the film 28 (exposed or otherwise) could be mass-duplicated for a few cents per copy, ability to monitor and verify accurate recordings; and/or the ability to use a single non-mechanical device for both data recordation and retrieval. The amount of data that can be stored in this system may be limited only by the resolution and speed of the electron-sensitive film. As these limitations are reduced, the capacity of data for a 35 mm square film could be increased in excess of 5 tera-bytes. Although data compression techniques as known by those of ordinary skill in the art may be employed to increase the data capacity of a film, the data density of the film may allow for high volumes of uncompressed data storage without compromising the speed of read and write operations due to compression or decompression processes.

Those skilled in the art will further appreciate that, although the invention has been described in connection with certain embodiments, there is no intent to limit the invention thereto. On the contrary, the intention of this application is to cover all modifications and embodiments fairly falling within the scope of the appended claims either literally or under the doctrine of equivalents.

1. An apparatus for recording and retrieving digital data on a film comprising:
a vacuum enclosure having an input and an output;
an electron gun disposed at the input of the vacuum enclosure and arranged to discharge a beam of electrons into the vacuum enclosure;
an input circuit operatively coupled to the vacuum enclosure and the electron gun, and arranged to adjust a characteristic of the electron beam to selectively expose portions of a film to thereby record digital data on the film without moving the film;
a target disposed at the second end of the vacuum tube and arranged to generate signals indicative of stored digital data when exposed to electrons from the electron beam passing through exposed portions of the film.

2. An apparatus as defined in claim 1 further comprising a support arranged to secure a sheet of film between the output of the vacuum enclosure and the target such that electrons from the electron beam pass through exposed portions of the film when the film is secured to the support.

3. An apparatus as defined in claim 1 further comprising an output circuit operatively coupled to the target and arranged to couple the data signals generated by the target to an external output device.

4. An apparatus as defined in claim 1 further comprising a power supply and a biasing resistor operatively coupled to the target.

5. An apparatus as defined in claim 1 wherein the target comprises an anode target arranged to generate anode current indicative of the stored digital data when exposed to electrons from the electron beam passing through exposed portions of the film.

6. An apparatus as defined in claim 1 further comprising an error correction circuit operatively coupled to the target and the input circuit, and arranged to compare a data signal generated by the target with a control grid signal generated by the input circuit.

7. An apparatus as defined in claim 1 further comprising a beam deflection system arranged to direct the electron beam to follow a controlled path.

8. An apparatus as defined in claim 7 wherein the controlled path is continuous.

9. An apparatus as defined in claim 7 wherein the beam deflection system comprises an electrostatic system.

10. An apparatus as defined in claim 7 wherein the beam deflection system comprises deflection electrodes and a deflection control circuit.

11. An apparatus as defined in claim 10 wherein the deflection control circuit comprises a synchronization generator.

12. An apparatus as defined in claim 7 wherein the beam deflection system comprises a generator arranged to control a retrieval rate to direct a playback speed.

13. An apparatus as defined in claim 7 wherein the beam deflection system is arranged to direct the electron beam towards at least one location on the film to retrieve data stored on the film without moving the film.

14. An apparatus as defined in claim 7 wherein the beam deflection system is arranged to direct the electron beam to traverse predetermined locations on the film.

15. An apparatus as defined in claim 14 wherein the predetermined locations are identified by referencing a target location on the film.

16. An apparatus as defined in claim 7 wherein the predetermined system is arranged to playback a continuous stream of data stored on the film.

17. An apparatus as defined in claim 1 further comprising one or more focusing lenses associated with the vacuum enclosure and arranged to focus the electron beam discharged by the electron gun.

18. An apparatus as defined in claim 17 wherein the one or more focusing lenses are arranged to focus the electron beam to a tip of less than 25 microns.

19. An apparatus as defined in claim 17 wherein the one or more focusing lenses comprise electrostatic focusing lenses.

20. An apparatus as defined in claim 1
wherein the electron gun comprises a control grid;
wherein the input circuit comprises a grid control circuit operatively coupled to the control grid; and
wherein the control grid and the grid control circuit are arranged to modulate the electron beam between on and off states representative of digital data.

21. An apparatus as defined in claim 20 wherein the control grid and the grid control circuit are arranged to modulate the beam to controllably switch between a natural threshold of radiation associated with the film.

22. An apparatus as defined in claim 1 wherein the input circuit is arranged to modulate the electron beam to selectively expose the portions of the film to create a pattern of at least partially transparent spots corresponding to digital data.

23. An apparatus as defined in claim 1
wherein the input circuit is arranged to maintain the characteristic of the electron beam to pass electrons through at least partially transparent spots corresponding to digital data without exposing portions of the film; and
wherein the target is arranged to generate the data signals when the electron beam traverses a spot on the target through the at least partially transparent spots.

24. An apparatus as defined in claim 1 wherein the input circuit is arranged to cause the electron beam to remain in an on state throughout a recording process.

25. An apparatus as defined in claim 1 wherein the input circuit is arranged to periodically record variable coordinate values with the digital data to facilitate playback.

26. An apparatus as defined in claim 25 wherein the variable coordinate values are referenced to a predefined location on the film.

27. An apparatus as defined in claim 26 wherein a reference target is recorded at the predefined location on the film.

28. An apparatus as defined in claim 1 wherein the film is electron sensitive.

29. An apparatus as defined in claim 1 wherein the film comprises a write once, read many film.

30. An apparatus as defined in claim 1 wherein the film comprises a write many, read many film.

31. An apparatus for recording and retrieving digital data on a film comprising:
a vacuum tube having first and second ends;
an electron gun disposed at the first end of the vacuum tube and arranged to discharge a beam of electrons into the vacuum tube;
an input circuit operatively coupled to the vacuum tube and the electron gun,
the input circuit being arranged to adjust a characteristic of the electron beam to selectively expose portions of a film to thereby record digital data on the film without moving the film;
the input circuit being arranged to maintain the characteristic of the electron beam to pass electrons though exposed portions of the film to thereby read digital data on the film without moving the film;
a target disposed at the second end of the vacuum tube and arranged to generate signals indicative of stored digital data when exposed to electrons from the electron beam passing through exposed portions of the film.

32. An apparatus as defined in claim 31 further comprising a support arranged to secure a sheet of film between the second end of the vacuum tube and the target such that electrons from the electron beam pass through exposed portions of the film when the film is secured to the support.

33. An apparatus as defined in claim 31 further comprising an output circuit operatively coupled to the target and arranged to couple the data signals generated by the target to an external output device.

34. An apparatus as defined in claim 31 wherein the target comprises an anode target arranged to generate anode current indicative of the stored digital data when exposed to electrons from the electron beam passing through exposed portions of the film.

35. An apparatus as defined in claim 31 further comprising an error correction circuit operatively coupled to the target and the input circuit, and arranged to compare a data signal generated by the target with a control grid signal generated by the input circuit.

36. An apparatus as defined in claim 31 further comprising a beam deflection system arranged to direct the electron beam to follow a controlled path.

37. An apparatus as defined in claim 31 further comprising one or more focusing lenses associated with the vacuum tube and arranged to focus the electron beam discharged by the electron gun.

38. An apparatus as defined in claim 31
wherein the electron gun comprises a control grid;
wherein the input circuit comprises a grid control circuit operatively coupled to the control grid; and
wherein the control grid and the grid control circuit are arranged to modulate the electron beam between on and off states representative of digital data.

39. An apparatus as defined in claim 38 wherein the control grid and the grid control circuit are arranged to modulate the beam to controllably switch between a natural threshold of radiation associated with the film.

40. An apparatus for recording and retrieving digital data on a film comprising:
a vacuum tube having first and second ends;
an electron gun disposed at the first end of the vacuum tube and arranged to discharge a beam of electrons into the vacuum tube;
an input circuit operatively coupled to the vacuum tube and the electron gun, and arranged to adjust a characteristic of the electron beam to selectively expose portions of a film;
an anode target arranged to generate anode current indicative of stored digital data when exposed to electrons from the electron beam passing through exposed portions of the film;
a support arranged to secure a sheet of film between the second end of the vacuum tube and the anode target such that electrons from the electron beam pass through exposed portions of the film when the film is secured to the support; and
an output circuit operatively coupled to the anode target and arranged to couple the anode current generated by the anode target to an external output device.

41. An apparatus as defined in claim 40 wherein the target comprises an anode target arranged to generate anode current indicative of the stored digital data when exposed to electrons from the electron beam passing through exposed portions of the film.

42. An apparatus as defined in claim 40 further comprising an error correction circuit operatively coupled to the target and the input circuit, and arranged to compare a data signal generated by the target with a control grid signal generated by the input circuit.

43. An apparatus as defined in claim 40 further comprising a beam deflection system arranged to direct the electron beam to follow a controlled path.

44. An apparatus as defined in claim 40 further comprising one or more focusing lenses associated with the vacuum tube and arranged to focus the electron beam discharged by the electron gun.

45. An apparatus as defined in claim 40
wherein the electron gun comprises a control grid;
wherein the input circuit comprises a grid control circuit operatively coupled to the control grid; and
wherein the control grid and the grid control circuit are arranged to modulate the electron beam between on and off states representative of digital data.

46. An apparatus as defined in claim 45 wherein the control grid and the grid control circuit are arranged to modulate the beam to controllably switch between a natural threshold of radiation associated with the film.
